(19) United States
(12) Patent Application Publication
(10) Pub. No.: US 2003/0204642 A1
(43) Pub. Date: Oct. 30, 2003

(54) System and method for creating a communication connection

(76) Inventors: Michael Sanders, The Sea Ranch, CA (US); Brad Nelson, Coeur D'Alene, ID (US)

Correspondence Address: Fay Kaplun & Marcin, LLP, 150 Broadway, Suite 702, New York, NY, 10038, US

(21) Appl. No.: 10/136,768

(22) Filed: Apr. 30, 2002

(51) Int. Cl. G06F 9/46

(52) U.S. Cl. 709/313

(57) ABSTRACT

A method, comprising the steps of receiving a first communication from a service module, the first communication including a service module identifier, a service identifier, a service communication function pointer and a subscription function pointer, assigning an agent service identifier representing an available service corresponding to the service identifier, storing the agent service identifier, the service identifier, the service communication function pointer and the subscription function pointer, and sending a second communication to the service module, the second communication including the agent service identifier.

### BACKGROUND INFORMATION

The public switched telephone network (“PSTN”) is the world's collection of interconnected voice-oriented public telephone networks. The PSTN is an aggregation of circuit switching telephone networks which route phone calls between consumers. Today, the PSTN is almost entirely digital technology, but some analog remnants remain (e.g., the final link from a central office to the user). The transmission and routing of calls via the PSTN is governed by a set of standards so that various providers of telephone service may easily route calls between their customers. Thus, a first consumer having telephone service A is able to call a second consumer having telephone service B, and the routing of such a call may go through networks owned by various other telephone services C-E. The result being the appearance of a seamless transmission between the first and second consumers.

As an alternative to using standard telephones on the PSTN, consumers may also use their personal computers (“PCs”) to make phone calls to other PC users. The transmission of a call via a PC is generally referred to as Voice over Internet Protocol (“VoIP”) technology. VoIP is a set of facilities for managing the delivery of voice information using the Internet Protocol. These PC to PC phone calls are transmitted via the Internet. However, in some instances, a consumer on a standard telephone desires to call a consumer using a PC phone, or vice versa. Thus, standards have been developed to effectively route these types of phone calls.

### SUMMARY OF THE INVENTION

A method, comprising the steps of receiving a first communication from a service module, the first communication including a service module identifier, a service identifier, a service communication function pointer and a subscription function pointer. Assigning an agent service identifier representing an available service corresponding to the service identifier, storing the agent service identifier, the service identifier, the service communication function pointer and the subscription function pointer, and sending a second communication to the service module, the second communication including the agent service identifier.

A system, comprising a delivery agent, the delivery agent configured to receive a first communication from a service module, the first communication including a service module identifier, a service identifier, a service communication function pointer and a subscription function pointer, assign an agent service identifier representing an available service corresponding to the service identifier, store the agent service identifier, the service identifier, the service communication function pointer and the subscription function pointer, and send a second communication to the service module, the second communication including the agent service identifier.

Furthermore, a system, comprising a service module providing a service, a client module subscribing to the service, and a delivery agent configured to deliver messages between the client module and the service module, wherein the service module announces the availability of the service through a first communication to the delivery agent and the client module subscribes to the service through a second communication to the delivery agent.

In addition, a method, comprising the steps of announcing the availability of a service provided by a service module via a first communication from the service module to a delivery agent, requesting the service via a second communication from a client module to the delivery agent, establishing a binding between the client module and the service module to subscribe the client module to the service.

A method, comprising the steps of creating a communication connection between a client module and a service module, the communication connection including a delivery agent, sending a message to the delivery agent via a communication by one of the client module and service module, the communication including first data identifying the communication connection and the one of the client module and service module initiating the communication, and sending the message to the other one of the client module and the service module by the delivery agent, wherein the delivery agent includes second data identifying the other one of the client module and service module based on the first data included in the communication.

### BRIEF DESCRIPTION OF DRAWINGS

FIG. 1 shows an exemplary network arrangement for the connection of voice communications;

FIG. 2 shows an exemplary block diagram of modules to implement the SS7 protocol on a hardware component according to the present invention;

FIG. 3 shows an exemplary relationship between modules according to the present invention;

FIG. 4 shows an exemplary method to establish a SAP binding between a service module and a client module according to the present invention;

FIG. 5 shows exemplary SAP bindings between a service module and a client module and a service module and a delivery agent according to the present invention;

FIG. 6 shows exemplary primitives exchanged by the SCCP module as both a client and a service according to the present invention;

FIG. 7 shows an exemplary primitive exchange between a client module and a service module using a queue according to the present invention;

FIG. 8 shows an exemplary implementation of a module table in the delivery agent according to the present invention.

### DETAILED DESCRIPTION

The present invention may be further understood with reference to the following description of preferred exemplary embodiments and the related appended drawings, wherein like elements are provided with the same reference numerals. The exemplary embodiments described herein refer to voice communications (e.g., phone calls). However, those of skill in the art will understand that the present invention may be equally applied to systems, networks and/or hardware used for communication of data or other information. In this description of exemplary embodiments of the present invention, the terms switching and routing as applied to communications will be used interchangeably. Those of skill in the art will understand that in the context of voice and/or data communications a switch and a router generally perform different functions. However, in the context of the present invention, it is only important to understand that switches, routers and any other hardware equipment may be used to direct the communication through a network so that the communication is transmitted to the desired end location. Those of skill in the art also understand the basic concepts of the transmission of voice and/or data information across network devices. Those who desire a more detailed discussion of network data transfer may consult a reference such as, Perlman, Radia “Interconnections Second Edition—Bridges, Routers, Switches, and Internetworking Protocols,” Addison Wesley, 2000.

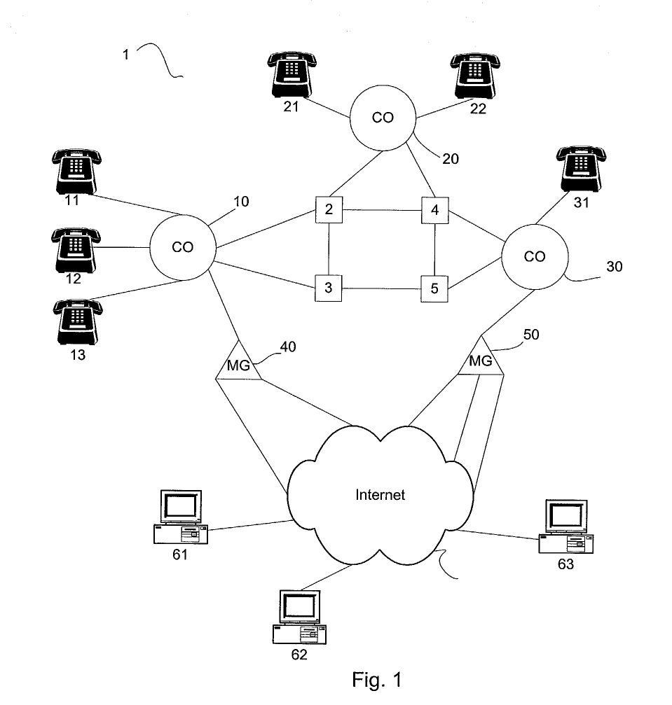

FIG. 1 shows an exemplary network arrangement 1 for the connection of voice communications. The network arrangement 1 includes three central offices (“CO”) 10-30 which are locations where telephone companies terminate customer lines and locate switching equipment to interconnect those lines with other networks. In this example, the customer lines 11-13 terminate at the CO 10, the customer lines 21-22 terminate at the CO 20 and the customer line 31 terminates at the CO 30. The customer lines may be any type of lines, for example, plain old telephone service (“POTS”) lines, integrated services digital network (“ISDN”) lines, frame relay (“FR”) lines, etc. In this example, each of the customer lines (e.g., customer line 11) may be considered a POTS line attached to a standard telephone at the customer location.

Between the COs 10-30, there may be a series of switching stations 2-5. These switching stations 2-5 direct the calls along a route from a transmitting CO to a receiving CO. For example, a user on the customer line 11 may attempt to call a user at the customer line 31. The call will be transmitted from the customer line 11 to the CO 10, which will then route the call into the system to arrive at the CO 30. When the call is in the system, it may take a variety of routes between the CO 10 and the CO 30 based on various parameters, e.g., system traffic, shortest route, unavailable switches, etc. In this example, the call may be routed from the CO 10 to the switching station 2, through to the switching station 4 and then to the CO 30 which connects the call to the customer line 31. The portion of the network arrangement 1 described above may be considered the PSTN portion of exemplary network arrangement 1.

In addition, there may be a VoIP portion of network arrangement 1. In this example, personal computers (“PC”) 61-63 are equipped with hardware and software allowing users to make voice phone calls. The PCs 61-63 have connections to the Internet 60 for the transmission of the voice data for the phone calls made by the users. If a PC user makes a voice call to another PC user (e.g., user of PC 61 calls user of PC 62), the call may be routed from the PC 61 through the Internet 60 to the PC 62. However, for calls from the PSTN portion of the network arrangement 1 to the VoIP portion, media gateways (“MG”) 40-50 act as a router for such calls. Thus, if the user of PC 61 calls the user of customer line 31, the call may be routed from the PC 61 through the Internet 60 to the MG 50 and through to the CO 30 which connects the call to the customer line 31. Those of skill in the art will understand that the previously described components are only exemplary and that there may be other components used to route calls, for example, the VoIP portion of the network may contain a media gateway controller.

As seen from the above described examples, the phone calls are routed through the exemplary network arrangement 1 by a variety of hardware devices (e.g., COs, switching stations, MGs, etc.). Standards groups have been set up to promulgate standards for the protocols to route these phone calls through the various telephone systems. For example, Signaling System 7 (“SS7”) is a telecommunications protocol defined by the International Telecommunications Union (“ITU”). For a more detailed discussion of SS7 see the following standard publication, “ANSI, T1. 110-1992, Signaling System 7 (SS7) General Information, 1992” and the sequence of standards, ANS1, T1.111-114, related to SS7. In general, the SS7 protocol is implemented on the PSTN portion equipment (e.g., CO 10-30, switching stations 2-5) and may be used for a variety of features related to phone calls, for example, basic call setup, management, tear down, local number portability, toll-free and toll wireline services, call forwarding, three-way calling, etc.

Another example of a protocol standard for the VoIP portion of network arrangement 1 is the MEGACO standard by the Internet Engineering Task Force (“IETF”). For a more detailed discussion of the MEGACO standard see the following publication, “IETF, RFC 3015, Megaco Protocol Version 1.0.” MEGACO defines the protocols used between elements of a physically decomposed multimedia gateway consisting of a MG (e.g., MGs 40-50) and a Media Gateway Controller. Those of skill in the art will understand that the above described protocols are only exemplary and there are additional implemented protocols and new protocols that may be implemented in the future and the present invention is equally applicable to any of these systems implementing protocols.

Thus, each of the described components in network arrangement 1 may implement a variety of protocols to route calls to the desired location. The described components may include one or more processors or other computing devices to provide the desired functionality (e.g., routing of the phone calls, etc.). Thus, these components may contain software components to instruct the processor (or other computing device) to perform the desired functions and implement the various protocols. The present invention may be implemented on any of the above described components or any other processor based components used in the transfer of information through a network.

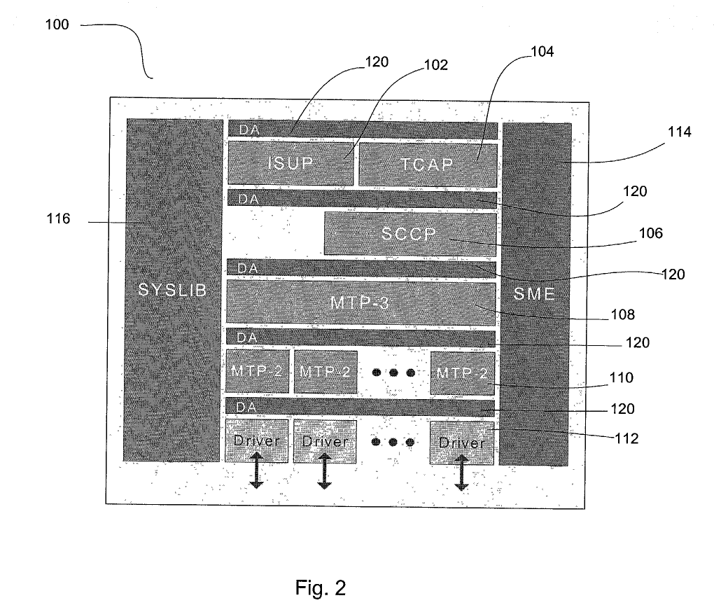

FIG. 2 shows an exemplary block diagram of a system 100 of modules to implement the SS7 protocol on a hardware component. For example, switching station 2 may implement the modules described in FIG. 2 in order to provide the functionality related to the SS7 protocol (e.g., 800 number look-up, etc.). An exemplary embodiment of the present invention will be described in reference to the exemplary block diagram 100 for implementing the SS7 protocol. However, those of skill in the art will understand that the present invention may be implemented on a variety of hardware devices that implement any protocol and is not limited to the modules described in this exemplary embodiment. A brief description of the SS7 modules and their functions will be given. However, the present invention is not dependent on the SS7 protocol or any protocol.

The drivers 112 provide the interface between the software and the physical hardware device. The drivers 112 may be considered the lowest level layer in the protocol. Generally, the drivers 112 provide services such as the initialization of hardware and hardware support tasks, hardware management and data packet transfer. However, the specific tasks accomplished by the drivers 112 are highly dependent on the underlying hardware device. For example, in the case of switches, the drivers 112 may be responsible for switch and port statistic retrieval and management.

The Message Transfer Part, Level 2 (“MTP-2”) modules 110 provide link-layer functionality such as error checking, flow control and sequence checking so that two endpoints of the signaling link can reliably exchange signaling messages. The Message Transfer Part, Level 3 (“MTP-3”) module 108 provides network layer functionality, for example, node addressing, routing, alternate routing and congestion control to ensure that messages can be delivered between signaling points across the SS7 network.

The Signaling Connection Control Part (“SCCP”) module 106 provides transport layer functionality to address an application within a signaling point. Examples include 800 calls and calling card calls. The Integrated Services Digital Network User Part (“ISUP”) module 102 provides call control functionality to define the messages and protocol used for the establishment and tear down of both ISDN and non-ISDN voice and data calls. The ISUP module 102 provides support for features such as, enbloc and overlap sending, link-by-link signaling using a pass-along method, end-to-end signaling using SCCP method, local number portability, message segmentation, etc. The Transaction Capabilities Application Part (“TCAP”) module 104 provides session layer functionality to define the messages and protocol used to communicate between applications in signaling nodes. The TCAP module 104 may be used for database services such as calling card, 800 calls and repeat dialing.

The System Management Entity (“SME”) module 114 provides three main functions. First, the initialization, configuration, and control for the different modules and the entire system 100. Second, a database of configuration and management information. Third, system logging, tracing, event handling and statistical functions. The SME module 114 provides an alternate data path for the configuration data from each of the different layers. Thus, each layer does not need to know the configuration data from the other layers. For example, in the context of the protocol, the MTP-3 module 108 does not need to pass its configuration data to any of the other layers, e.g., MTP-2 module 110, SCCP module 106, etc.

The System Library module 116 provides an abstraction between the protocol software and the actual operating system of the hardware device. This eliminates the need to depend on the system interface defined for a particular operating system and allows the exemplary SS7 modules to be ported between various operating systems and kernels without any modification. The functionality provided by the System Library module 116 may include, for example, buffer manipulation, interrupt locking, memory manipulation, signaling/semaphore, message logging, timers, vector management, etc. In addition to the modules shown in FIG. 2, the system 100 may also include application layer modules (not shown) to provide specific applications to the user. The application layer modules may be represented as being above the layer including the ISUP module 102 and the TCAP module 104.

As shown in FIG. 2, a delivery agent 120 is interposed between each of the various layers of modules. For example, there is a delivery agent 120 situated between the MTP-3 module 108 and the MTP-2 module 110. The delivery agent 120 provides a portable mechanism that the modules may use to exchange information. The delivery agent 120 is a common method of interface between each of the modules. The delivery agent 120 allows a user of the system 100 to enter the system at any level because the interface for the modules is common at every level. It may also allow a user to decompose the system into several subsystems and isolate modules into tasks for the purpose of providing redundancy and reliability. For example, the MTP-2 module 110 may be implemented on several hardware cards within the switch on which the system is being implemented. In such a case, the delivery agent 120 may be distributed over multiple hardware platforms. In contrast, the MTP-3 module 108 may be implemented on a single card within the same switch. A different delivery agent 120 may be interposed between each of the separate MTP-2 modules 110 and the MTP-3 module 108. However, the functionality of the delivery agent 120 is common. Likewise, the delivery agent 120 interposed between the MTP-3 module 108 and the MTP-2 module 110 is the same as the delivery agent 120 interposed between the SCCP module 106 and the TCAP module 104.

Those of skill in the art will understand that as previously described, the system 100 implicates multiple instances of the delivery agent 120. The system 100 may also be implemented with only a single instance of the delivery agent open. In such a case, the representation of FIG. 2 of multiple delivery agents 120 will remain the same, but the functionality of each of the delivery agents 120 will be handled by a single instance. As described above, the use of the SS7 protocol is only exemplary, the delivery agent 120 may be used in any protocol stack in either the PSTN portion or the IP portion of the network arrangement 1. The functionality of the delivery agent 120 will be described in greater detail below.

Each of the modules within system 100 may have a client and/or service relationship with other modules. In general, a lower level layer module will provide a service to a higher level layer module. In this case, the higher level layer module will be a client of the lower level layer module. For example, the SCCP module 106 may provide services to the ISUP module 102 and the TCAP module 104, i.e., ISUP module 102 and TCAP module 104 are clients of the SCCP module 106. Whereas, the SCCP module 106 may be a client of the MTP-3 module 108 services.

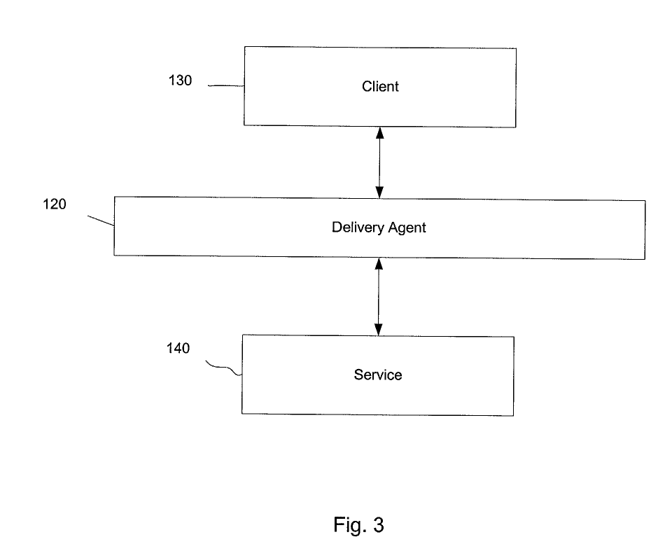

FIG. 3 shows an exemplary relationship between modules according to the present invention. In this example, there is a client module 130, a delivery agent 120 and a service module 140. As described above, any of the modules described with reference to FIG. 2 may be either a client module 130 or a service module 140. Each of the service modules 140 have a documented set of services that it may make available to any of its client modules 130. For example, a module acting in the capacity of a service module may make (n) services available to potential clients. A particular client module may wish to subscribe to one or all of the (n) services offered by the service module. In the case where the client module subscribes to all (n) services, there remains one service module and one client module, but there are (n) client-service relationships (or bindings) between the modules. Throughout this description, the relationship between the client and service is intended to mean the subscription by a client to a particular service (an individual binding). However, this relationship may also be referred to in the context of a relationship between a client module and a service module.

The service module 140 may announce the availability of a particular service to the delivery agent 120. This announcement may occur any time during the operation of the system. If for some reason the service becomes unavailable, then the service module 140 may announce this removal of the service to the delivery agent 120. The client module 130 may gain access to a service by requesting a binding with the service via the delivery agent 120. The binding between a client module 130 and a service module 140 maybe referred to as a Service Access Point (“SAP”). Once the SAP binding is created either the service module 140 or the client module 130 may exchange information with the module to which it is bound.

This exchange of information will occur through the common method of interface, the delivery agent 120. For example, if the TCAP module 104 is a client of the SCCP module 106, each of the modules may exchange information. This exchange of information between a service module 140 and a client module 130, or vice versa, may be referred to as an exchange of messages referred to herein as “primitives”. Primitives are basic units of information and may be divided into various classes including requests, confirmations, rejects, responses and indications. The primitives will be described in greater detail below.

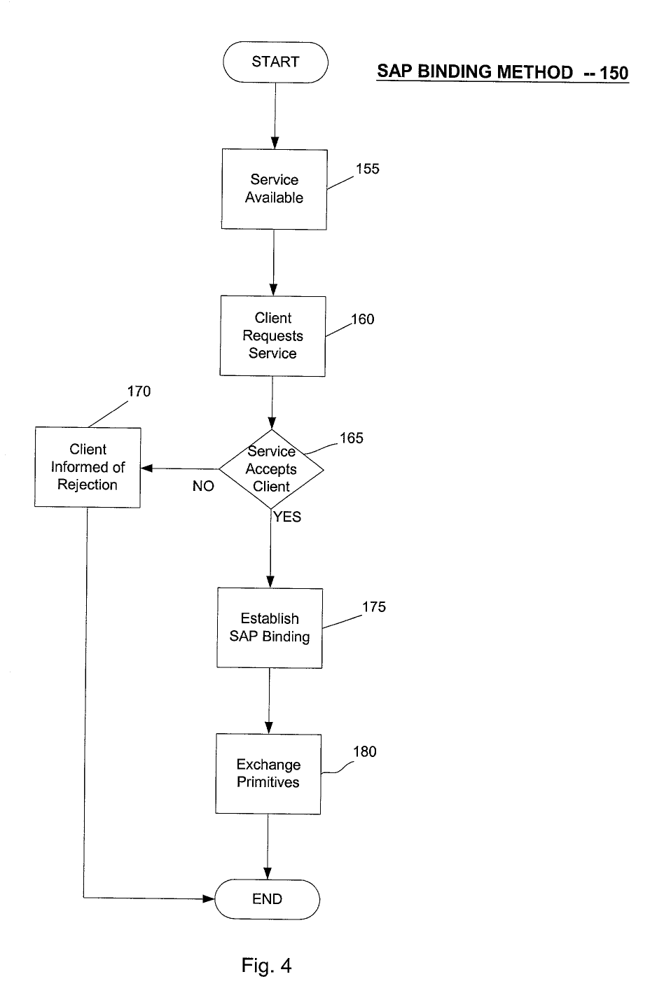

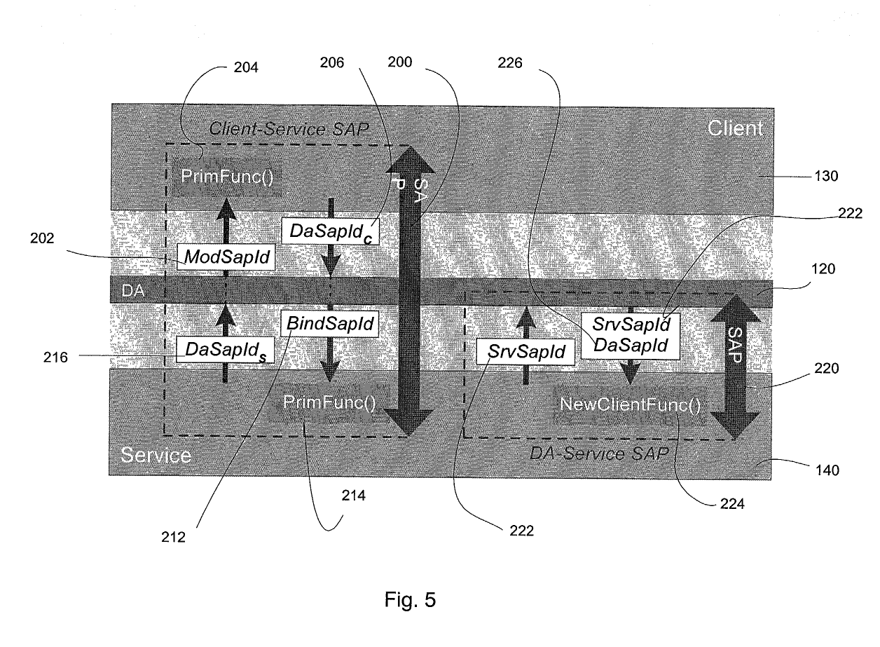

FIG. 4 shows an exemplary method 150 to establish a SAP binding between a service module 140 and a client module 130. The method 150 will be described with reference to the exemplary modules of FIG. 3 and the exemplary SAP bindings illustrated in FIG. 5. FIG. 5 shows exemplary SAP bindings 200 and 220 between a service module 140 and a client module 130 and a service module 140 and a delivery agent 120, respectively. In step 155, the service module 140 announces the availability of its service to the delivery agent 120. The announcement by the service module 140 may be in the form of a communication to delivery agent 120, such as a call to a function located in the delivery agent 120. Such a function may be called a DaAddService( ) function. The purpose of calling the DaAddService( ) function is to create the SAP binding 220 (FIG. 5) between the service module 140 and the delivery agent 120. Each of the SAP bindings 200 and 220 is a collection of information that may be used to identify the individual binding and to allow the modules to quickly and easily distinguish between different bindings. The SAP W binding 220 facilitates new client bindings to the service module 140. Those of skill in the art will understand that the communication between the service module and the delivery agent may be in other forms besides function calls, for example, message based delivery such as message passing, mail or inter-task messaging. In this description it should be understood that any reference to communications between modules (or delivery agent and modules) via function calls is only exemplary and that the communications may be carried out in different manners, for example, message passing.

When the service module 140 calls the DaAddService( ) function, the call may include a series of arguments. Exemplary arguments may include a pointer to the address of a service module 140 function that the delivery agent 120 may use to deliver new client subscription requests, the new client function 224. In this description the term address will be used to describe a location of a function or other executable entity. The term address should be construed in the broadest sense to mean any manner of identifying a location for an executable entity. Another exemplary argument may be the address of the service module 140 communication function that the delivery agent 120 may use to deliver primitives from the client module 130 to the service module 140, the primitive function 214. The arguments described in the calls to any functions in this description are only exemplary. Those of skill in the art will understand that a call to a function may include any number of arguments based on all the tasks that may be carried out by a particular function.

The service module 140 may also provide a service SAP ID 222 in the call to the DaAddService( ) function. The service SAP ID 222 is a unique identifier for the service being offered that the delivery agent 120 may use in calls to the new client function 224 so that the service module 140 may distinguish between the multiple services it may offer. When the delivery agent 120 makes a call to the new client function 224 of the service module 140 in order to attempt to add a new client, the delivery agent 120 may supply the service SAP ID 222 so the service module 140 may understand the service which the client is requesting. In addition, the delivery agent 120 may also supply a delivery agent service SAP ID 226 so the service module 140 may identify the delivery agent 120 in subsequent calls.

At the completion of step 155, the SAP binding 220 is established and the service of the service module 140 is registered as available with the delivery agent 120. The SAP binding 220 may contain information including the service SAP ID 222, the address of the new client function 224 and the delivery agent service SAP ID 226. Those of skill in the art will understand that the SAP binding 220 may also contain additional information on the binding.

In step 160, the client module 130 requests use of the available service from the delivery agent 120. The request by client module 130 may be in the form of a communication with the delivery agent 120, such ads a call to a function located in the delivery agent 120 called a DaAddClient( ) function. The purpose of calling the DaAddClient( ) function is to initiate the creation of the SAP binding 200 (FIG. 5) between the service module 140 and the client module 130. The arguments passed to the DaAddClient( ) function may include a pointer to the address of the client module 130 communication function 204 that the delivery agent 120 may use to deliver primitives from the service module 140 to the client module 130. The client module 130 may also supply a module SAP ID 202 that the delivery agent 120 may use to identify the binding in calls back to the client module 130 when the SAP binding 200 is established. The number or other identifier selected by the client module 130 for the module SAP ID 202 may or may not have intrinsic meaning. For example, to the delivery agent 120 the module SAP ID 202 may have no meaning. Whereas, to the client module 130, the module SAP ID 202 may be an index to a table, a pointer to a context block, or some other manner in which the client module 130 may quickly access information about the SAP binding 200. Additional arguments may also include the identifier for the service that was assigned by the service module for the particular service. The delivery agent 120 may use this service identifier to identify the particular service to which the client module 130 desires to subscribe. The client module 130 may also include a primitive (referenced by a pointer to a primitive data structure) that can be passed to the service module 140 with information relevant to the subscription request.

The delivery agent 120, when executing the DaAddClient( ) function, may use the information in the SAP binding 220, to attempt to create the SAP binding 200 between the client module 130 and service module 140. The delivery agent 120 may pass the request to the service module 140 new client function 224 including the service SAP ID 222, both of which are contained in the SAP binding 220. The service module 140 receives the request and identifies the requested service by the service SAP ID 222. The service module 140 may then respond back by either accepting or rejecting the client (step 165). This response may include the delivery agent service SAP ID 226 contained in the SAP binding 220 so the delivery agent 120 may identify the particular service module 140 from which the response originated. This is an example of how the SAP binding 220 may facilitate communication between the service module 140 and the delivery agent 120, specifically for new client bindings. Those of skill in the art will understand that the information contained in SAP binding 220 may also be used for other communication purposes in addition to new client bindings, since the SAP binding 220 essentially opens a fast and effective communications link between service module 140 and the delivery agent 120.

If, in step 165, the service module 140 does not accept the client module 130, the service module 140 informs the delivery agent 120 of this rejection. The reasons for a rejection may include, for example, a lack of a resource (e.g., not enough memory), a service only allows one client of each type (e.g., the MTP-3 module 108 has an ISUP module 102 bound as a client, the MTP-3 module 108 may reject another module claiming to be an ISUP module 102), etc. In step 170, the delivery agent 120 then informs the client module 130 that it has not been accepted as a client for the requested service, for example, by sending a primitive indicating the rejection, and the process of creating the SAP binding 200 between that particular client module 130 and the service of service module 140 is discontinued. However, the SAP binding method 150 may continue for other client modules because the service module 140 continues to make its service available to other potential clients via the delivery agent 120.

If, in step 165, the service module 140 accepts the client module 130, the service module 140 informs the. delivery agent 120 of this acceptance and the establishment of the SAP binding 200 is continued (step 175). The delivery agent 120 may also return a delivery agent client SAP ID 206 to the client module 130 when executing the DaAddClient( ) function. The delivery agent client SAP ID 206 may be used to identify the SAP binding 200 in subsequent calls from the client module 130 to the delivery agent 120. The delivery agent client SAP ID 206 is similar to the delivery agent service SAP ID 226 generated by the delivery agent 120 when calling the new client function 224 of the service module 140. However, the value of each delivery agent client SAP ID 206 and delivery agent service SAP ID 226 is unique to identify the relationship between the delivery agent 120 and the individual client and/or service binding. There is also a delivery agent service SAP ID 216 which may be used to identify the SAP binding 200 in subsequent calls from the service module 130 to the delivery agent 120.

When the service module 140 is executing the new client function 224 in order to add a new client, the service module 140 may supply the delivery agent 120 with a binding SAP ID 212 that the delivery agent 120 may then use to identify the SAP binding 200 in subsequent calls to the service module 140. As previously described, when the service module 140 makes a call to the DaAddService( ) function it also may pass the address for the service module 140 primitive function 214 which also may be information included in the SAP binding 200. When the new client function 224 has been executed, the delivery agent 120 establishes the SAP binding 200 between the service module 140 and the client module 130 by delivering a primitive to the primitive function 204 of the client module 130 indicating that a path between the client and service has been established and is ready for the exchange of primitives. As described above, when the client module 130 requests the service by calling the delivery agent 120 DaAddClient( ) function, the arguments may include a pointer to the address of the client module 130 primitive function 204. Thus, in step 175, the delivery agent 120 is able to deliver the primitive indicating the open path to the address indicated by the client module 130 for its primitive function 204.

At the completion of step 175, the SAP binding 200 is established and there is a path open for the exchange of primitives between the service module 140 and the client module 130. The information contained in SAP binding 200 may include the address of the client primitive function 204, the address of the service primitive function 214, the module SAP ID 202, the binding SAP ID 212, the delivery agent client SAP ID 206 and the delivery agent service SAP ID 216. This information contained in the SAP binding 200 between the client module 130 and the service module 140 facilitates the exchange of primitives between the modules.

After the SAP binding 200 is established in step 175, the client module 130 and the service module 140 are free to exchange primitives in step 180. This exchange of primitives may be carried out through a communication with the delivery agent 120, such as by a call to a function located in the delivery agent 120 called a DaSendPrim( ) function. The client module 130 may include a primitive handler to prepare a primitive to be sent to the service module 140. The client module 130 may then call the DaSendPrim( ) function of the delivery agent 120. The arguments with the call may include the delivery agent client SAP ID 206 which identifies the SAP binding 200 for the delivery agent 120. Additional arguments may also include a primitive identifier, a pointer to the primitive buffer, a pointer to the information block for the primitive and the number of bytes in the information block.

The control of the primitive has then passed from the client module 130 to the delivery agent 120. The delivery agent 120 also has enough information to direct the primitive to the correct service module 140. Based on the passed delivery agent client SAP ID 206, the delivery agent 120 identifies the client-service SAP binding including the pointer to the service module 140 primitive function. The delivery agent 120 may then pass the primitive to the correct service module 140 using the binding SAP ID 212 which identifies the SAP binding 200 for the service module 140. The primitive function 214 of the service module 140 then performs its actions on the primitive. The service module 140 is aware which client module 130 sent the primitive because it is identified with the SAP binding 200. Additional details of the primitive exchange will be described in greater detail below.

The above example described a primitive exchange from the client module 130 to the service module 140, but those of skill in the art will understand that the exchange may occur in the opposite direction from the service module 140 to the client module 130 in the same manner. The primitive handler of the service module 140 prepares the primitive to be sent and calls the appropriate delivery agent 120 function with the corresponding arguments (e.g., delivery agent service SAP ID 216). The delivery agent 120 then calls the primitive function of the client module 130 with the corresponding arguments (e.g., module SAP ID 202) and the primitive is transferred to the client module 130.

Once the SAP binding is established, it is a symmetrical path, i.e., the service module 140 and the client module 130 may equally initiate the exchange of primitives. To continue with the example, when the service module 140 desires to send a primitive to the client module 130, the service module 140 also calls the DaSendPrim( ) function of the delivery agent 120. The arguments in the call may include the delivery agent service SAP ID 216 which identifies the SAP binding 200 for the delivery agent 120. The delivery agent 120 may then pass the primitive to the correct client module 130 using the module SAP ID 202 which identifies the SAP binding 200 for the client module 130. The primitive function 204 of the client module 130 then performs its actions on the primitive. The client module 130 is aware which service module 140 sent the primitive because it is identified with the SAP binding 200.

The delivery agent 120 may also have complimentary functions to the DaAddService( ) and DaAddClient( ) functions for removing services and clients, respectively. Thus, when a client module 130 no longer desires to be a client for a particular service, the client module 130 may call the remove client function, DaRemClient( ), to sever the SAP binding 200 between the client module 130 and the service module 140. In addition, the service module 140 may also call the DaRemClient( ) function to terminate a binding with a client. Similarly, when the service module 140 no longer desires to make a service available, the client module 140 may call the remove service function, DaRemService( ), to remove the service from the available services list and sever any existing SAP bindings to clients of that service.

When the service module 140 makes it service available, multiple client modules 130 may become clients of the service. This may result in the service module 140 exchanging primitives with a series of client modules 130. A client module 130 may be a client of multiple service modules 140 because it is accessing the services that are made available by these multiple service modules 140. This may result in a client module 130 exchanging primitives with a series of service modules. Therefore, when a client module 130 or a service module 140 desires to exchange a primitive with a corresponding module, it needs to be able to identify the destination module for the primitive. In addition, when communicating between different layers the layers need to know the context of the communication. By using the various information contained in the SAP binding (e.g., SAP IDs, addresses for functions, etc), the modules can easily pass the primitives from the source to the correct destination including the context information. This manner saves processor and memory resources over using specific address locations and look up tables.

As described above, primitives may be divided into various classes including requests, confirmations, rejects, responses and indications. Requests are made by a client module 130 to a service module 140 and initiate some service action. Confirmations are made by the service module 140 to the client module 130 and are made to confirm a previous request. Similarly, rejects are made by the service module 140 to the client module 130 and are made to reject a previous request. Indications are made by the service module 140 to the client module 130 to indicate some activity at the service layer. Responses are made by a client module 130 to a service module 140 and are done in response to a previous indication. It is not necessary for an indication to have a corresponding response or a request to have a corresponding confirmation or reject. A primitive may include a unique primitive identifier to identify the primitive, a pointer to an optional data buffer containing data associated with the primitive and a pointer to an information structure which may contain additional information for the primitive. Those of skill in the art will understand that the described elements of a primitive are only exemplary and that primitives may contain additional information. Exemplary primitives will be described below.

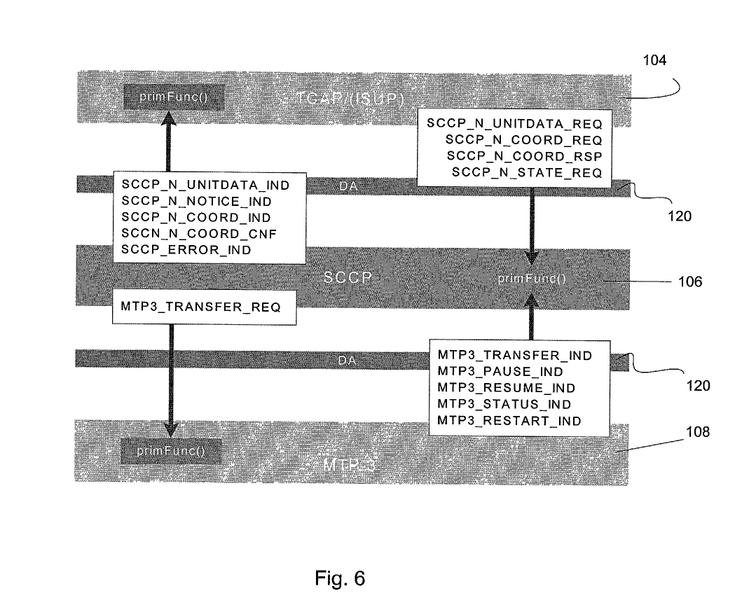

FIG. 6 shows exemplary primitives exchanged by the SCCP module 106 as both a client and a service. In this example the SCCP module 106 is a client of the MTP-3 module 108 and a service for the TCAP module 104. In the example where the SCCP module 106 is a client of MTP-3 module 108, the primitive exchange initiated by the SCCP module 106 includes the primitive MTP3_TRANSFER_REQ. This primitive is a request by the client module 130 (i.e., SCCP module 106) to the service module 140 (i.e., MTP-3 module 108) to initiate the action of sending data to a remote SCCP peer. In this example, the MTP-3 module 108 does not include a corresponding confirmation primitive. As shown in FIG. 6, the MTP-3 module 108 (acting as a service) includes a series of indication primitives that may be sent to the SCCP module 106 to indicate activity taking place in the service. For example, the MTP3_TRANSFER_IND indicates the delivery of data received from a remote SCCP peer.

In the example where the SCCP module 106 provides a service to the TCAP module 104, the primitive exchange initiated by the TCAP module 104 includes a series of requests (e.g., SCCP_N_UNITDATA_REQ, SCCP_N_COORD_REQ and SCCP_N_STATE_REQ). The SCCP module 106 has a corresponding confirmation for the SCCP_N_COORD_REQ, i.e., SCCP_N_COORD_CNF. Thus, the TCAP module 104 may initiate a request by sending the primitive SCCP_N_COORD_REQ to the SCCP module 106. In this example, the SCCP_N_COORD_REQ is a request used by replicated subsystems to coordinate the withdrawal of one of the subsystems. The primitive function of the SCCP module 106 will operate on the primitive and extract the necessary information from the primitive to determine the requested action. The SCCP module 106 will then send the confirmation primitive SCCP_N_COORD_CNF to the TCAP module 104 to confirm that the request was received. The primitive function of the TCAP module 104 will operate on the primitive and extract the information confirming the request.

Similarly, the SCCP module 106 (acting as a service) may initiate an exchange of primitives with the client, the TCAP module 104 in the form of the indication primitives (e.g., SCCP_N_UNITDATA_IND, SCCP_N_NOTICE_ND, SCCP_N_COORD_IND and SCCP_ERROR_IND) In this example, the TCAP module 104 may respond to the corresponding indication by sending a response primitive to the SCCP module 106 (e.g., SCCP_N_COORD_RSP).

However, as described above and as shown in FIG. 6, each of the these exchanges of primitives is not a direct exchange between client and service (or vice versa), but is through the delivery agent 120. In the example above involving the exchange of the primitive SCCP_N_COORD_REQ from the TCAP module 104 to the SCCP module 106, the primitive is first delivered from the TCAP module 104 to the delivery agent 120 and then from the delivery agent 120 to the SCCP module 106. As described above, before this exchange of primitives may occur, there is a client-service SAP binding created between the TCAP module 104 and the SCCP module 106 which may include a series of SAP IDs in order for each module to direct the primitive to the correct module.

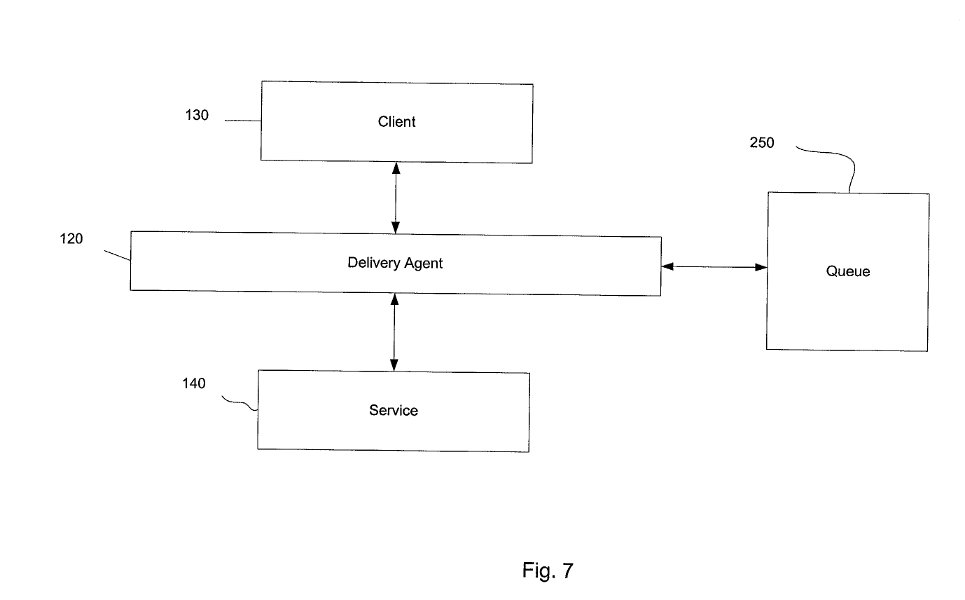

FIG. 7 shows an exemplary primitive exchange between a client module 130 and a service module 140 using a queue 250. In this example the primitive may be sent from the client module 130 to the service module 140, but the same process is available for primitive exchanges in the opposite direction. When the delivery agent 120 receives the primitive from the client module 130 to transfer to the service module 140, it may check whether the service module 140 is available. If the service module 140 is available, it may transfer the primitive in the manner described above, i.e., by calling the service module 140 primitive function. However, if the service module 140 is busy (e.g., processing other primitive data), the delivery agent may send the primitive to the queue 250. The primitive may then wait in the queue 250 until the service module 140 is available, at which time, the primitive information is retrieved from the queue 250 and transferred to the service module 140 using primitive function 214.

The exemplary embodiment of the present invention may implement a variety of queuing options. For example, there may be a single queue 250 for the entire system. In this scenario all the modules (e.g., ISUP module 102, TCAP module 104, SCCP module 106, MTP-3 module 114, etc.), acting as both clients and services, may share the same queue 250. In another example, the modules operating in the same thread may share a queue 250, i.e., one queue 250 per thread. In a further example, each module may have an individual queue 250. Those of skill in the art will understand that another benefit from using a queue 250 may be the elimination of re-entrancy issues associated with the sending and receipt of multiple primitives. In addition to the information passed with the primitive, the queue 250 may also contain flags which indicate various properties, for example, if the primitive has been allocated from the heap or from the caller's stack.

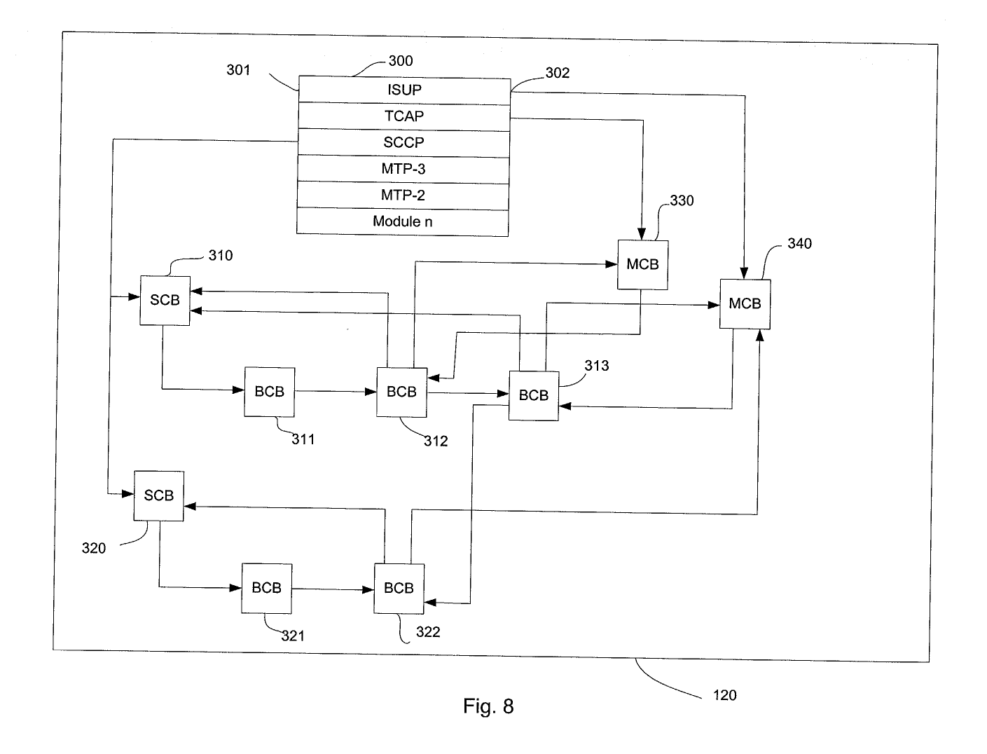

FIG. 8 shows an exemplary implementation of a module table 300 in the delivery agent 120. The module table 300 and the associated control blocks 310-340 shown in FIG. 8 illustrate an exemplary manner in which the delivery agent 120 may store and retrieve information about individual modules and SAP bindings. In this example, module table 300 includes entries for the modules described in exemplary system 100 of FIG. 2. Those of skill in the art will understand that the module table 300 may contain entries for any number of modules based on the particular system that may be implementing the present invention. For example, if a system has twenty-five modules that may act as services or clients, the module table may include entries for all twenty-five modules. Those of skill in the art will also understand that module table 300 may be implemented in a variety of different manners, for example, as an array, a linked list, a context table, etc.

Each individual entry in the module table 300 may have pointers to information for the individual module when it is acting as a service or a client. In FIG. 8, it may be considered that the lines leaving from the left side 301 of the module table 300 indicate pointers to information about a module when the module is acting in the capacity of a service. For example, the line leaving the SCCP entry from the left side 301 of the module table 300 indicate pointers to data concerning the SCCP module 106 when it is acting in the capacity of a service. In contrast, the lines leaving from the right side 302 of the module table 300 indicate pointers to information about a module when the module is acting in the capacity of a client. For example, the line leaving the TCAP entry from the right side 302 of the module table 300 indicate pointers to data concerning the TCAP module 104 when it is acting in the capacity of a client. As described previously, individual modules may act as both service modules and client modules, therefore, a single module entry may point to both client and service information.

The service information for a module may be contained in a service control block (“SCB”), for example, SCBs 310 and 320. In this example, both the SCBs 310 and 320 are from the SCCP entry in module table 300. This indicates that the SCCP module 106 is making two services available to its client modules. The first service may be associated with SCB 310 and the second service may be associated with SCB 320. The SCB 310 may be created when the SCCP module 106 calls the DaAddService( ) function of the delivery agent 120 to make the service available. For example, the SCCP module 106 may pass a service SAP ID 222, a primitive function 214 address, a new client function 224 address, etc., when making the call to the DaAddService( ) function. The delivery agent 120 may use this information to create the SCB 310 with a pointer from the module table SCCP entry. Similarly, the SCCP module 106 will pass the same information (the second service will have a different service SAP ID 222 than the first service) when it calls the DaAddService( ) function to make the second service available. The delivery agent 120 may then create the SCB 320 with this information with a pointer from the SCCP entry because this second service is also being offered by the SCCP module 106.

Those of skill in the art will understand that the SCBs (e.g., SCB 310 and 320) may be any manner of storing data in a processor arrangement, for example, a table, an array, a context block, pointers to internal or external memory locations, etc. Although not shown in this example, each of the module table 300 entries may have pointers to SCBs for each of the services that are presently being offered by the module corresponding to the entry. An SCB may be considered to contain the information for the delivery agent-service SAP binding 220 as described with reference to FIG. 5.

The client information for a module may be contained in a module control block (“MCB”), for example, MCBs 330 and 340. In this example, the MCB 330 is from the TCAP entry and the MCB 340 is from the ISUP entry in module table 300. The MCB 330 may be created when the TCAP module 104 calls the DaAddClient( ) function of the delivery agent 120 to subscribe to an available service. For example, the TCAP module 104 may pass a module SAP ID 202, a primitive function 204 address, etc., when making the call to the DaAddClient( ) function. The delivery agent 120 may use this information to create the MCB 330 with a pointer from the module table TCAP entry. Similarly, when the ISUP module 102 calls the DaAddClient function, the delivery agent 120 may create the MCB 340. In this example, the ISUP module 102 has made two requests for different services resulting in the pointer from the ISUP entry in module table 300 to MCB 340.

Information about specific SAP bindings may be contained in a binding control block (“BCB”), e.g., BCBs 311, 312, 313, 321 and 322. Each time a client-service SAP binding (e.g., SAP binding 200 of FIG. 5) is created, the delivery agent 120 may create a BCB to store information about the specific SAP binding. The BCB may contain information about the binding and/or have pointers to other storage locations that contain the information. Thus, a BCB may have a pointer back to the SCB for the service module and the MCB for the client module. For example, the TCAP module 104 may desire to subscribe to a service of the SCCP module 106. This service of the SCCP module 106 may be represented in the SCB 310 (i.e., the delivery agent-service SAP binding information) and the information about the client module (e.g. TCAP module 104) may be included in the MCB 330. When the client-service SAP binding is created between the SCCP module 106 and the TCAP module 104, the delivery agent 120 creates the BCB 312 to contain the information about that particular client-service SAP binding. The BCB 312, in addition to holding information about the SAP binding, may also have a pointer back to the SCB 310 for the service and the MCB 330 for the client. Through the module table 300, the delivery agent 120 may have access to all the information about any particular active SAP binding. The module table 300, SCB 310, MCB 330 and BCB 312 may contain (or point to) all the relevant information for the delivery agent 120, client module 130 and service module 140 with respect to the individual SAP binding.

As shown in FIG. 8, the BCBs may be included in a linked list or other similar format. For example, the BCBs 311, 312 and 313 represent three distinct bindings between clients and the first service offered by the SCCP module 106 as represented in SCB 310. Those of skill in the art will understand that the MCBs may also have a linked list through the BCBs. For example, MCB 340 has a linked list including BCB 313 and 322 representing bindings to the ISUP module 102 as a client. In this example, BCB 312 represents the binding between the TCAP module 104 (client) and SCCP module 106 (service), BCB 313 represents the binding between the ISUP module 102 (client) and SCCP module 106 (service), and BCB 311 represents a binding between the SCCP module 106 (service) and a client module that is not shown in FIG. 8. The number of BCBs linked to an SCB represents the number of client-service SAP bindings there are for a particular service. As described above, the system may implement a queue or a series of queues. The SCB, MCB or BCB may have pointers to such queues in order to retrieve information when it is stored in the queues.

The delivery agent 120 may allocate memory dynamically to the SCBs, MCBs and BCBs. For example, when a service is made available by a service module 140, the delivery agent 120 may then allocate memory for an SCB to contain information about the service (e.g., the delivery agent-service SAP binding). Similarly, when a client module 130 calls the DaAddClient( ) function, the delivery agent 120 may then allocate memory for an MCB to contain information about the client. When the service is no longer available or the client no longer desires to be subscribed to the service (e.g., the delivery agent 120 DaRemService( ) function or DaRemClient( ) function are called), the memory for the SCB and MCB may remain allocated or be de-allocated by the delivery agent 120. Those of skill in the art will understand that each scheme may have benefits. For example, the de-allocation of memory may result in the maintenance of less memory and less fragmentation of the memory. Whereas, leaving the memory allocated to the SCB and/or MCB after the service or client is discontinued, may result in less processing if the client or service is to be reinstated at a later time. Similarly, when a client-service SAP binding is established, the delivery agent 120 may then allocate memory for the BCB to contain information about the SAP binding. The memory for the BCB may also be de-allocated when the SAP binding is severed.

To complete the description of FIG. 8, the ISUP module 102 is shown as being a client of both the available services of the SCCP module 106. The MCB 340 (ISUP module 102) has a pointer from BCB 313 indicating that the ISUP module 102 is a client of the service associated with SCB 310 (SCCP module 106) and a pointer from BCB 322 indicating that the ISUP module 102 is a client of the service associated with SCB 320 (SCCP module 106).

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising the steps of:
receiving a first communication from a service module, the first communication including a service module identifier, a service identifier, a service communication function pointer and a subscription function pointer;
assigning an agent service identifier representing an available service corresponding to the service identifier;
storing the agent service identifier, the service identifier, the service communication function pointer and the subscription function pointer; and
sending a second communication to the service module, the second communication including the agent service identifier.

2. The method of claim 1, wherein each communication is one of a function call, a return from the function call, and an inter-task message.

3. The method of claim 1, further comprising:
receiving a third communication from a client module, the third communication including a client module identifier, the service module identifier, a client binding identifier and a client communication function pointer;
assigning an agent-service binding identifier representing a binding with the service module for the available service, and an agent-client binding identifier representing a binding with the client module for the available service;
sending a fourth communication to the service module via the subscription function pointer, the fourth communication including the service identifier, the agent-service binding identifier and the client module identifier;
sending a fifth communication to the client module, the fifth communication including the agent-client binding identifier. receiving a sixth communication from the service module, the sixth communication including a service binding identifier; and
storing the agent-client binding identifier, the agent-service binding identifier, the service binding identifier, the client binding identifier, the client communication function pointer and the service communication function pointer.

4. The method of claim 3, wherein the sixth communication further includes an indication of whether subscription to the available service has been accepted by the service module, and further comprising:
sending an eleventh communication to the client module via the client communication function pointer, the eleven th communication including the client binding identifier and a pointer to a subscription result message structure, the subscription result message structure including a result based on the indication of whether subscription to the available service has been accepted.

5. The method of claim 3, further comprising:
receiving a seventh communication from the client module, the seventh communication including the agent-client binding identifier and a message structure pointer; and
sending an eighth communication to the service module via the service communication function pointer, the eighth communication including the service binding identifier and the message structure pointer.

6. The method of claim 5, wherein the message structure pointer points to a primitive data buffer.

7. The method of claim 3, further comprising:
receiving a ninth communication from the service module, the ninth communication including the agent-service binding identifier and a message structure pointer; and
sending an tenth communication to the client module via the client communication function pointer, the tenth communication including the client binding identifier and the message structure pointer.

8. The method of claim 7, wherein the message structure pointer points to a primitive data buffer.

9. A system, comprising:
a delivery agent, the delivery agent configured to
receive a first communication from a service module, the first communication including a service module identifier, a service identifier, a service communication function pointer and a subscription function pointer;
assign an agent service identifier representing an available service corresponding to the service identifier;
store the agent service identifier, the service identifier, the service communication function pointer and the subscription function pointer; and
send a second communication to the service module, the second communication including the agent service identifier.

10. The system of claim 9, further comprising:
the service module including a service communication function and a subscription function.

11. The system of claim 9, wherein the delivery agent is further configured to:
receive a third communication from a client module, the third communication including a client module identifier, the service module identifier, a client binding identifier and a client communication function pointer;
assign an agent-service binding identifier representing a binding with the service module for the available service, and an agent-client binding identifier representing a binding with the client module for the available service;
send a fourth communication to the service module via the subscription function pointer, the fourth communication including the service identifier, the agent-service binding identifier and the client module identifier;
send a fifth communication to the client module, the fifth communication including the agent-client binding identifier. receive a sixth communication from the service module, the sixth communication including a service binding identifier; and
store the agent-client binding identifier, the agent-service binding identifier, the service binding identifier, the client binding identifier, the client communication function pointer and the service communication function pointer.

12. The system of claim 11, wherein the sixth communication further includes an indication of whether subscription to the available service has been accepted by the service module, and the delivery agent is further configured to:
send an eleventh communication to the client module via the client communication function pointer, the eleventh communication including the client binding identifier and a pointer to a subscription result message structure, the subscription result message structure including a result based on the indication of whether subscription to the available service has been accepted.

13. The system of claim 11, further comprising:
the client module including a client communication function.

14. The system of claim 11, wherein the delivery agent is further configured to:
receive a seventh communication from the client module, the seventh communication including the agent-client binding identifier and a message structure pointer; and
send an eighth communication to the service module via the service communication function pointer, the eighth communication including the service binding identifier and the message structure pointer.

15. The system of claim 14, wherein the message structure pointer points to a primitive data buffer.

16. The system of claim 11, wherein the delivery agent is further configured to:
receive a ninth communication from the service module, the ninth communication including the agent-service binding identifier and a message structure pointer; and
send an tenth communication to the client module via the client communication function pointer, the tenth communication including the client binding identifier and the message structure pointer.

17. The system of claim 16, wherein the message structure pointer points to a primitive data buffer.

18. A system, comprising:
a service module providing a service;
a client module subscribing to the service;
a delivery agent configured to deliver messages between the client module and the service module, wherein the service module announces the availability of the service through a first communication to the delivery agent and the client module subscribes to the service through a second communication to the delivery agent.

19. The system according to claim 18, wherein the first communication creates a binding between the delivery agent and the service module, the binding including information which allows the delivery agent to access functions included in the service module.

20. The system according to claim 19, wherein the binding further includes information which allows the service module to identify the delivery agent when accessing the functions.

21. The system according to claim 18, wherein the second communication creates a binding between the service module and the client module.

22. The system according to claim 21, wherein the information includes a location of a function in the client module accessible by the delivery agent to pass messages to the client module.

23. The system according to claim 21, wherein the information includes a location of a function in the service module accessible by the delivery agent to pass messages to the service module.

24. The system according to claim 18, further comprising:
a queue for storing messages before delivery to one of the client module and the service module.

25. A method, comprising the steps of:
announcing the availability of a service provided by a service module via a first communication from the service module to a delivery agent;
requesting the service via a second communication from a client module to the delivery agent;
establishing a binding between the client module and the service module to subscribe the client module to the service.

26. The method of claim 25, further comprising the step of:
exchanging messages from the client module to the service module via the delivery agent.

27. The method of claim 25, wherein the first communication establishes a binding between the service module and the delivery agent.

28. The method of claim 25, further comprising the step of:
removing the service from availability via a third communication from the service module to the delivery agent.

29. A delivery agent, comprising:
a first module creating a first binding between the delivery agent and a service module, the first binding including first data corresponding to a service offered by the service module; and
a second module creating a second binding between the service module and a client module, wherein the client module is subscribing to the service, the second binding including second data for delivering messages between te service module and the client module.

30. The delivery agent of claim 29, wherein the first data includes a pointer to a new client function of the service module, the delivery agent calling the new client function to add a client to the service offered by the service module.

31. The delivery agent of claim 30, wherein the first data further includes a service identifier to identify the service offered by the service module, the delivery agent including the service identifier when calling the new client function.

32. The delivery agent of claim 29, wherein the first data includes a delivery agent service identification to identify the first binding, the service module including the delivery agent service identification when communicating with the delivery agent corresponding to the service.

33. The delivery agent of claim 29, wherein the second data includes a module identification to identify the second binding, the delivery agent including the module identification when communicating with the client module.

34. A method, comprising the steps of:
creating a communication connection between a client module and a service module, the communication connection including a delivery agent;
sending a message to the delivery agent via a communication by one of the client module and service module, the communication including first data identifying the communication connection and the one of the client module and service module initiating the communication; and
sending the message to the other one of the client module and the service module by the delivery agent, wherein the delivery agent includes second data identifying the other one of the client module and service module based on the first data included in the communication.

35. The method of claim 34, further comprising the step of:
storing the message in a queue before sending the message to the other one of the client module and the service module.
